(19) United States
(12) Patent Application Publication
(10) Pub. No.: US 2010/0215244 A1
(43) Pub. Date: Aug. 26, 2010

(54) ARRANGEMENT AND METHOD FOR DIGITAL MAMMOGRAPHY IMAGING

(76) Inventor: Pekka Strömmer, Helsinki (FI)

Correspondence Address: Juan Carlos A. Marquez;c/o Stites & Harbison PLLC, 1199 North Fairfax Street, Suite 900, Alexandria, VA, 22314-1437, US

(21) Appl. No.: 12/734,006

(22) PCT Filed: Oct. 3, 2008
(86) PCT No.: PCT/FI2008/050549

§ 371 Date: Apr. 2, 2010

(30) Foreign Application Priority Data
Oct. 4, 2007 (FI) 20075701

(51) Int. Cl. G06K 9/00

(52) U.S. Cl. 382/132

(57) ABSTRACT

The invention relates to an arrangement and a method in digital mammography imaging, wherein X-radiation is produced by an X-radiation source (2), the radiation produced is filtered and the radiation containing image information is detected by means of an imaging sensor (5). According to a preferred embodiment of the invention, the X-radiation is produced using an acceleration voltage of over 30 kV and a tungsten anode, the radiation emitted from the anode (11) is filtered using a silver filter (13) substantially having a thickness of about 75 μm, and the radiation containing image information is detected by means of a sensor based on amorphous selenium technology.

The present invention relates to an arrangement as defined in the preamble of claim 1 and to a method for digital mammography imaging as defined in the preamble of claim 9.

Breast cancer is the most common type of cancer in women. According to researches, about one in every ten women contract breast cancer at some point in their lives. When breast cancer is detected on the basis of symptoms, the illness often has already developed to a stage where the prognosis for recovery is relatively poor. Part of the cases of breast cancer are detected in screening programs, which are arranged in many countries e.g. for women over the age of 40. In screening, cancer is often detected at a very early stage, so its treatment can be started in time and recovery is thus more likely.

Mammography imaging is a widely used method in breast cancer screening, as a clinical investigation method and also in follow-up diagnosis. Mammography imaging is an X-ray investigation method whereby X-ray imaging is implemented using an apparatus specifically designed for this purpose. In screening studies, mammography has been reported to have a sensitivity of 90-93% and a specificity of 90-97%. This indicates quite clearly that screening studies are useful and that early detection of breast cancer by screening can save human lives. It has been established that mammography reduces breast cancer mortality by 35 percent among women over 50 and by 25-35 percent among women at the age of 40-50 years.

In mammography imaging, the breast gland is compressed between two plates in an X-ray apparatus, and the breast thus compressed flat is exposed to radiation for taking at least two X-ray images, one from above and the other from an oblique direction. If necessary, additionally a third image is taken squarely from the side. The mammography images are examined to detect various anomalies in the breast, such as calcifications, i.e. small deposits of calcium in the soft breast tissue. A calcification generally cannot be detected by feeling the breast, but it is visible in the mammography X-ray image. Large calcifications are generally not associated with Cancer, but clusters of small calcium deposits, i.e. so-called micro-calcifications, are an indication of extra breast cell activity, which may be associated with breast cancer. Other features to be detected by mammography include cysts and fibroadenomas, which, however, are generally not associated with cancer.

The breast contains several structures that may cause problems in the interpretation of a mammography image. Also, many deposits are poorly visible in the images and may have soft and indefinite boundaries. In addition, in soft tissue the differences in contrast of the structures are often small, which causes further difficulties in the interpretation of mammography images. On the other hand, due to differences in breast size, it is difficult to produce images of uniform quality.

To allow results as reliable as possible to be obtained by mammography imaging, the image quality has to be as good as possible in respect of both resolution and contrast. In mammography, a radiation source producing low-energy radiation specifically designed for breast imaging is used. The aim is to obtain images of as high quality as possible for different breast thicknesses and by a radiation dose as small as possible. The average effective radiation dose in mammography imaging is typically about 0.2 mSv per exposure.

In mammography apparatuses, an acceleration voltage of 25-30 kV and a current of over 80 mA are generally used. One expedient for improving image quality would be to increase the radiation dose, but as this is impracticable due to reasons of radiation hygiene, it is necessary to resort to other expedients to find a solution.

Prior-art patent specifications include U.S. Pat. No. 5,375,158, which aims at reducing the radiation dose received by the patient without compromising on image quality, by using an arrangement where the anode material used in the X-radiation source is, especially, silver and the radiation filter is a silver filter having a thickness of about 30 μm. Tungsten is mentioned as an alternative anode material. The objective for these selections is announced to be producing X-radiation containing a large amount of 20-35 keV X-ray quanta.

Although the arrangement according to the above-mentioned patent specification supposedly does reduce the radiation dose received by the patient as compared to some other arrangements used in mammography apparatus, it would seem in the light of our investigations, however, that it does not yield results of the magnitude purported in the specification.

At a more general level, too, the specifications published in the art concerning digital mammography imaging contain many researches relating e.g. to the use of a tungsten anode and different filters, in which investigations the aim has been to find better combinations (compromises) between parameters such as image quality, exposure time, X-ray tube load and patient dose, as for example in Flynn M. et al., Optimal radiographic techniques for digital mammograms obtained with an amorphous selenium detector, Med. Imaging 2003, Proceedings of SPIE Vol. 5030 (2003). Flynn et al. as well as others have ended up with the conclusion that there is no sense to increase the thickness of the filter material beyond 50 μm, because doing so would only produce an excessive load on the X-ray tube without achieving any substantial advantage as far as other parameters are concerned.

The object of the present invention is to achieve a new kind of solution for digital mammography imaging that will make it possible to reduce the radiation dose received by the patient without compromising on image quality—or to make images of better quality using the same dose as in prior-art solutions but in such a way that the load imposed on the X-ray tube is not greater, or is even smaller, than in many prior art solutions.

According to the basic idea of the invention, the starting point adopted is to co-adapt the spectrum of the X-radiation produced in the radiation source on the one hand and, on the other hand, the properties of the radiation filter arranged in connection with the radiation source, and those of the imaging sensor used in the imaging, so as to allow the object being imaged to be exposed to a radiation spectrum which, on the one hand, contains no X-ray quanta having too low an energy level to be able to penetrate the object being imaged and which, on the other hand, contains plenty of X-ray quanta that, after having penetrated the object, are in an energy range optimal or nearly optimal in view of the properties of the sensor used for imaging, especially in view of the contrast of the image produced and the signal level attainable. Thus, according to the basic idea of the invention, an X-radiation spectrum is produced which, as a compromise, taking into account both the spectral changes occurring as the radiation is passing through the breast tissue being imaged and the spectral sensitivity of the imaging sensor, is advantageous in consideration of the image quality produceable by the arrangement and the amount of radiation absorbed by the object. In other words, image quality is contemplated here especially by considering the contrast of the image produced, which basically is the better the lower is the energy used for the imaging, and, on the other hand, the signal level, which has to be sufficiently high to ensure that the image produced will not be spoiled by noise.

The factors affecting the energy level and energy distribution in the spectrum of the X-radiation reaching the imaging sensor include the tube voltage, i.e. acceleration voltage used in the X-radiation source, the anode material, the filter material used for filtering the radiation, substantially expressly the thickness of this filter layer, as well as the thickness and structure of the breast being examined. All these circumstances have been taken into account in the quest for optimal parameter value combinations according to the invention. Moreover, the properties of the imaging sensor used in the apparatus, e.g. its reception that is quantum efficiency to the X-radiation spectrum, have an effect on the image quality and therefore on the most preferable embodiments of the arrangement according to the invention. The invention makes it possible to achieve a combination of properties of the radiation source, filter and imaging sensor that will produce a good imaging result with a relatively small radiation dose brought about on the patient.

The present invention emanates from our insight that in many of the prior art researches, wrongly weighted simulation models leading to erroneous conclusions have been used. In particular, we have discovered that, in contrast to what suggested by many earlier researches, by using certain combinations of values of tissue thickness and other parameters, it is possible to attain definitely better results with filter thicknesses that have previously been judged to be unsuitable.

The arrangement of the invention is characterized by what is disclosed in the characterizing part of claim 1, and the method of the invention is characterized by what is disclosed in the characterizing part of claim 9. Some other preferred embodiments of the invention are disclosed in the other claims.

What is substantive to the invention is that by using a filter layer thicker than those previously used or recommended to be used, it is possible to produce a spectrum that is substantially free of low-energy quanta and has an advantageous average energy/energy distribution in view of the properties of the sensor used for the imaging, considering the change in the spectrum since it having passed through the object being imaged.

One of the advantages of the solution of the invention is that it allows a good image quality to be achieved with a relatively small radiation dose, yet without overloading the X-ray tube.

In the following, the invention will be described in more detail by comparing some of its preferred embodiments to a few prior art embodiments and by referring to the attached drawings, from which

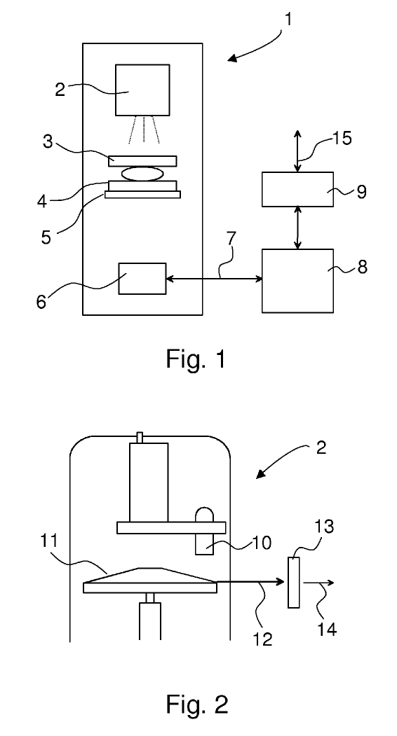

FIG. 1 is a generalized representation of a typical mammography arrangement in a simplified diagrammatic form,

FIG. 2 presents an X-radiation source applicable for use in the invention in a simplified diagrammatic form,

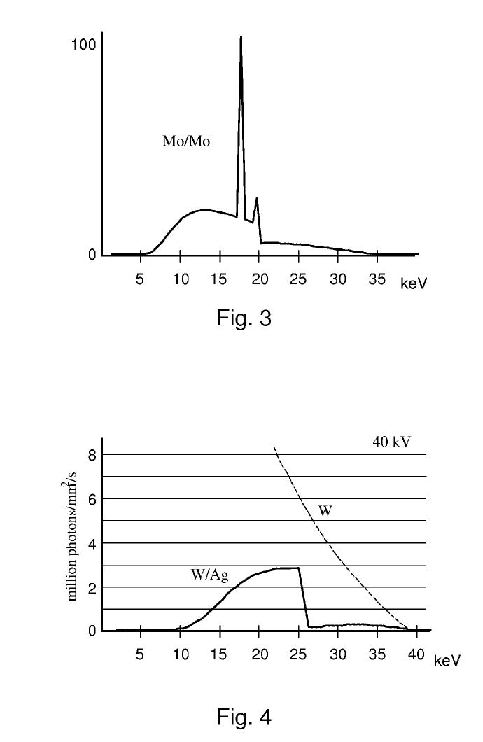

FIG. 3 presents a typical X-radiation spectrum in a generally used mammography arrangement, wherein a molybdenum anode/a molybdenum filter combination is used,

FIG. 4 presents an X-radiation spectrum obtained using a tungsten anode/a silver filter combination,

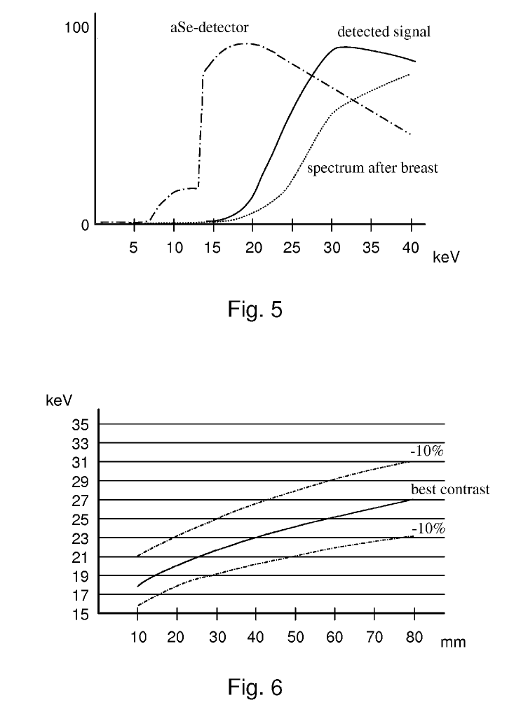

FIG. 5 illustrates sensor signal formation as a function of quantum energy in the case of a certain detector/breast thickness combination,

FIG. 6 shows the quantum energy level giving the best contrast as a function of breast thickness,

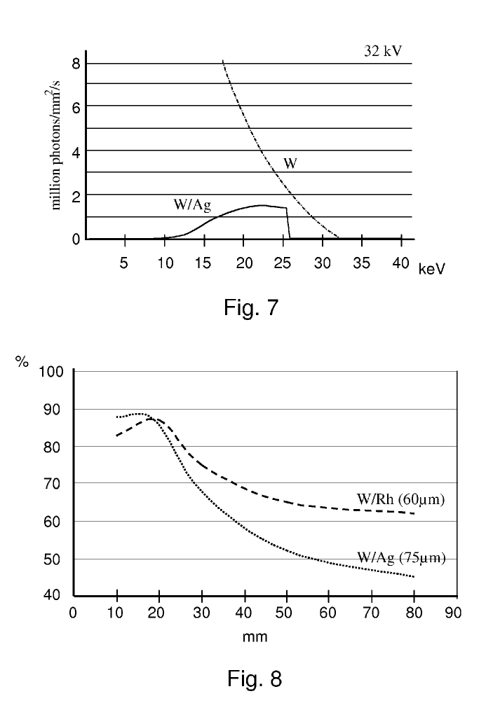

FIG. 7 presents a radiation spectrum used for imaging produced according to a preferred embodiment of the invention,

FIG. 8 represents the relative tissue dose in the case of tungsten anode/silver filtering and tungsten anode/rhodium filtering as compared to the molybdenum anode/molybdenum filter combination, as a function of tissue thickness,

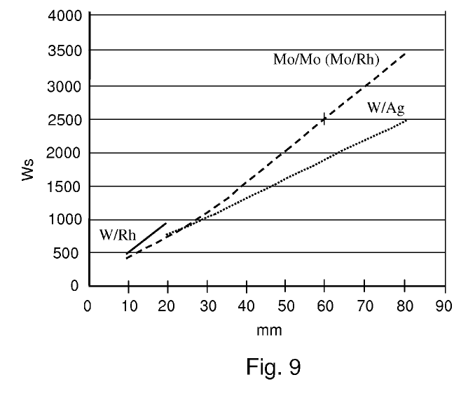

FIG. 9 represents the power requirement of the X-ray tube as a function of tissue thickness for certain anode material and filter alternatives.

FIG. 1 is a simplified and generalized representation of an arrangement for digital mammography imaging. The arrangement comprises a mammography unit 1, which contains a radiation source 2 producing X-radiation and an upper compression plate 3 and a lower compression plate 4, between which the breast to be imaged is compressed as flat as possible. The radiation penetrating the breast is passed to an imaging sensor 5, where, e.g. according to the so-called direct conversion principle, the X-radiation is converted directly into an electric signal and further into digital data. In a preferred embodiment of the invention, the detector material used is amorphous selenium (aSe).

The mammography unit 1 may contain a communication means 6 via which the mammography unit 1 communicates with other structures associated with the arrangement, such as e.g. an imaging work-station 8 and storage means 9, on which the images and related data have been arranged to be stored. In addition, it is possible to provide a connection 15 to external facilities, e.g. to an internal and external data network and via these e.g. to different data banks or corresponding applications.

FIG. 2 presents in a simplified diagrammatic form an X-radiation source 2 applicable for use in the invention. The radiation source 2 comprises a cathode 10 housed inside a protecting cover, and a rotating anode 11. The electrons on the cathode 10 have been arranged to be emitted from the cathode and impinge on the anode 11 at a high speed, with the result that part of the kinetic energy of the electrons is converted into radiation energy, which also contains X-rays 12 (X-ray quanta). The radiation source 2 is provided with a window (not shown in FIG. 2), through which the quanta emitted from the anode 11 in the direction of the window can pass further towards a radiation filter 13.

FIG. 3 presents a spectrum of X-radiation produceable by a prior art arrangement comprising a molybdenum anode and a molybdenum filter (Mo/Mo combination). In FIG. 3, the horizontal axis shows the quantum energy level and the vertical axis shows the relative amount of quanta (photons). The spectrum according to FIG. 3 is obtained using a Mo filter thickness of 30 μm, an acceleration voltage of 34 kV and a current of 80 mA. Here, the intensity maximum of the spectrum is at the energy level of 17.5 keV as is characteristic for molybdenum, and a second peak is at the 19.6 keV energy level. The mean energy level, i.e. average energy level of the quanta achieved is 18.1 keV.

The Mo filter is a so-called K-edge filter, which effectively absorbs low-energy radiation. The Mo filter also clearly cuts the higher end of the spectrum just above the K-edge, this cutting effect being represented in FIG. 3 by the large fall in the number of quanta immediately after the second peak at 19.6 keV. The Mo/Mo combination is well suited for film-based imaging and for imaging of thin breasts, where the tissue layer does not significantly absorb quanta of this energy level, but in the case of thicker tissue layers the situation is different.

FIG. 4 presents one characteristic X-radiation spectrum according to a solution of the invention, in an arrangement using a tungsten anode and a silver filter (W/Ag combination). In the figure, the so-called raw spectrum of non-filtered radiation is depicted by a dotted broken line and the spectrum of filtered radiation by a solid line. In this example, the Ag filter has a thickness of 75 μm, the acceleration voltage used is 40 kV and the current 80 mA. Compared to the spectrum presented in FIG. 3, the intensity maximum is now about 25.8 keV and the mean energy level 22 keV. As the number of quanta penetrating the tissue, i.e. the number of higher-energy quanta increases and the number of quanta absorbed in the tissue decreases, the radiation dose received by the object decreases but still a good imaging result can be achieved, as described in the following.

Let us now consider the situation with regard to how the image is formed on the sensor. Firstly, the dotted broken line in FIG. 5 shows how the signal level produced by an imaging sensor (disposed in the mammography apparatus below the lower compression plate) containing amorphous selenium changes as a function of quantum energy, with the assumption that the radiation reaching the compression plate contains a uniform amount of quanta in the energy range of 1-40 keV. The dotted line in FIG. 5 again represents the spectrum of radiation that has penetrated a breast having a thickness of 40 mm and average radiation absorption properties, with the assumption that the radiation reaching the breast contains a uniform amount of quanta in the energy range of 1-40 keV. The breast tissue absorbs low-energy quanta and—the more quanta/the higher-energy quanta, the thicker/the denser the tissue is. On the other hand, also those structures of the mammography apparatus that lie between the detector element of the sensor and the breast absorb especially low-energy quanta. Of the quanta reaching the detector, those having the lowest energy level can not be detected, and neither can those having the highest energy level as they pass through the detector without stopping. The solid line in FIG. 5 represents the signal obtainable from an aSe sensor in the above-described construction, with the assumption that the object is a 40 mm thick average breast and that the radiation reaching the breast contains a uniform amount of quanta in the energy range of 1-40 keV. One can see that, from this point of view, optimal results would be achieved by using for imaging such radiation having an intensity maximum of about 31 keV.

However, in respect of image formation, an additional circumstance to be considered is that, basically, the image contrast is the better the lower is the energy level used for imaging. In FIG. 6, this circumstance has been simulated with different breast thicknesses by showing the quantum energy giving the best contrast as a function of breast thickness. The topmost and bottommost curves represent −10% levels as compared to the maximum. One can read from the figure that, when the thickness of the compressed breast is in the range of 20-80 mm, the optimal imaging spectrum range in this consideration falls on the range of 20-27 keV.

One may go even further by optimizing the signal level in relation to the noise which is characteristic to X-radiation, and finally by proportioning this to the radiation dose achievable by the arrangement—taking also into account that the radiation sources used in mammography apparatus in practice cannot be loaded however one likes without incurring overheating problems. Thus, according to the preferred embodiment described in Greater detail above, i.e. by using a tungsten anode, silver filtering and a detector based on amorphous selenium, one optimum can be reached—based on comparisons not presented here in detail—using an acceleration voltage of about 32-35 kV and 75 μm Ag filtering. With this arrangement, the same image quality (contrast-to noise ratio (CNR)) is reached as with the above-described Mo/Mo combination but with 60% of the radiation dose produced by it. In FIG. 7, the broken line represents the raw radiation spectrum produced by a tungsten anode using a 32 kV acceleration voltage, while the solid line represents the spectrum of the radiation obtained from it via 75 μm Ag filtering. From FIG. 7 it can be seen that the average energy of the quanta used for imaging is now 21 keV and their distribution in the range of about 14-26 keV.

The above description is valid especially for thicker breast tissues, such as tissues over 20 mm or 40 mm thick, in the case of which the radiation dose on the whole is a greater problem than in the case of small breasts. In that case, the acceleration voltage is preferably in the range of 32-35 kV. As for the filter layer thickness, advantageous results according to the invention are achieved using filtering layers of the order of 60 μm and more.

FIG. 8 presents the tissue dose in the case of tungsten anode/silver filtering (75 μm; dotted line) and in the case of tungsten anode/rhodium filtering (60 μm; broken line) in relation to a molybdenum anode/molybdenum filter (30 μm), as a function of tissue thickness when image quality (contrast and noise, or contrast to noise ratio CNR) is kept constant. To emphasize the advantages of the invention, the comparison has been made with tissue thickness of over 60 mm to the Mo/Rh (25 μm) technique, which in prior art has typically been used in the case of thicker tissues to minimize the radiation dose. It can be seen from the figure that when using a tungsten anode with tissue thicknesses below 20 mm, the 60 μm Rh filter produces a somewhat better result than the 75 μm silver filter, and that both of them still produce a clearly smaller dose than the prior art solutions used as reference.

FIG. 9 represents the X-ray tube electric power needed to attain the same contrast to noise ratio (CNR) using a technique according to the present invention (tungsten anode/rhodium filtering (60 μm), solid line; tungsten anode/silver filtering (75 μm), dotted line) on the one hand and the Mo/Mo (30 μm, tissue thickness below 60 mm) and Mo/Rh (25 μm, tissue thickness over 60 mm) techniques on the other hand. The curves in FIG. 9 have been obtained by using a 29 kV acceleration voltage for tissue thicknesses below 20 mm and a 35 kV acceleration voltage for tissue thicknesses over 20 mm.

The results we have obtained clearly show the surprising fact that, by using in the context of the invention filters of a thickness definitely larger as compared to those used/recommended before, especially an Ag filter, and relatively high acceleration voltages, either an image quality corresponding to earlier quality levels is obtained with a smaller patient dose, or with a corresponding dose a better image quality is obtained. Moreover, the solutions according to the invention do not cause any new problems regarding the radiation source power requirement since as a consequence of using a higher kV, the exposure times can be correspondingly shortened, which reduces the load on the X-ray tube. In the comparison according to FIG. 9, a power level higher than those of the prior art solutions is only needed with tissue thicknesses below 20 mm, and when operating in this range the power requirement is in no way a limiting factor.

As the objects to be imaged in mammography vary so much in respect of their thickness and radiation absorption properties, it is natural that a parameter combination that is optimal for a given type of breast is not necessarily that for some other. However, the arrangement of the invention works in the intended manner as compared to the Mo/Mo combination used here as a reference, at least in the following ranges of parameter values: tungsten anode acceleration voltage over 30 kV (a practical maximum being of the order of 40 kV in the radiation sources currently used in mammography devices, while an optimum according to the invention is about 35 kV) and Ag filter layer thickness between 60-100 μm, preferably of the order of 75 μm. In a preferred embodiment of the invention, a breast compression thickness of about 20 mm is a limit value; in the case of breasts smaller than this, a Rh filter (at least) about 60 μm thick may preferably be used. These preferred embodiments of the invention primarily relate to a detector which is specifically based on the amorphous selenium technology, but they are not necessarily limited exclusively to it. It is also conceivable for the invention to be embodied using some other heavy filter material, such as palladium, tin or indium. The essential point is that in this case, too, a sufficiently large filtering layer thickness is used to prevent low-energy quanta from reaching the object to be imaged. The filter layer thickness is preferably at least about 60 μm, making it possible to reach a situation according to the preferred embodiments of the invention where at least most of at least the quanta having an energy level below 10 keV, such as below 12 keV, are caught in the filter.

We shall not attempt in this context to describe all the numerous simulations, experiments and measurement results which have led us to the present invention. We believe that the results already described above tell exhaustively enough of the dramatic conflict between the results obtainable by the invention and the teachings of the prior art, according to which there is no sense to even consider using very large filter thicknesses because doing so would only result in unnecessary (over)loading of the radiation source without achieving any remarkable advantages. The invention thus culminates in an arrangement in digital mammography imaging which comprises at least an X-radiation source, a radiation filter, a means for compressing the breast substantially immovable in the imaging region and an electric imaging sensor, wherein the radiation source comprises a tungsten anode and is arranged to produce an acceleration voltage of at least 30 kV and, especially when the breast compression thickness is over about 20 mm, the filter selected for use is a silver filter having a thickness of at least about 60 μm, e.g. about 75 μm. When the breast compression thickness is below about 20 mm, preferably a rhodium filter having a thickness of at least about 60 μm is selected for use.

Correspondingly, the invention can be conceived of as being crystallized as a mammography imaging method wherein the object to be imaged is compressed substantially immovable for an imaging operation, X-radiation is produced in an X-radiation source comprising a tungsten anode, the X-radiation is filtered by means of a radiation filter and the radiation having penetrated the object to be imaged and containing image information is detected by means of an electric imaging sensor, wherein, when the compression thickness of the object to be imaged is over about 20 mm, the X-radiation is produced using an acceleration voltage of over 30 kV and the radiation emitted from the anode is filtered by means of an Ag filter having a thickness of at least about 60 μm, e.g. about 75 μm. When the compression thickness is below about 20 mm, the radiation emitted from the anode can be advantageously filtered using a rhodium filter having a thickness of at least about 60 μm.

It is obvious to a person skilled in the art that the invention is not limited to the embodiments described above but that it may be varied within the scope of the claims presented below. Thus, for example, the structure of the mammography apparatus may differ from that described above in a general form. Likewise, e.g. the anode of the radiation source used may be mechanically implemented as other than a rotating structure.

1-17. (canceled)

18. An arrangement in digital mammography imaging, said arrangement comprising at least:
an X-radiation source; a radiation filter;
means for compressing a breast substantially immovable in the imaging region; and
an electric imaging sensor, wherein
the radiation source comprises a tungsten anode,
the radiation source is configured to produce an acceleration voltage of at least the order of 30 kV during an exposure,
when a compression thickness of the breast is over 20 mm, the filter is a silver filter having a thickness of at least 60 μm, and
the imaging sensor is configured with amorphous selenium technology.

19. The arrangement according to claim 18, wherein the thickness of the filter is less than 100 μm.

20. The arrangement according to claim 18, wherein the acceleration voltage is substantially in the range of 30-40 kV.

21. The arrangement according to claim 18, wherein the acceleration voltage is around 35 kV.

22. The arrangement according to claim 18, wherein the thickness of the silver filter is at least 75 μm.

23. The arrangement according to claim 18, wherein
the radiation source comprises a tungsten anode,
the radiation source is configured to produce an acceleration voltage substantially in the range of 32-35 kV,
the filter is a silver filter having a thickness of around 75 μm, and
the imaging sensor is configured to use amorphous selenium technology.

24. The arrangement according to claim 18, wherein, when a compression thickness of the breast is below 20 mm, the filter is a rhodium filter having a thickness of at least 60 μm.

25. A method for digital mammography imaging, comprising the steps of:
compressing an object to be imaged so as to be substantially immovable for the imaging;
producing X-radiation via an X-radiation source that comprises a tungsten anode;
filtering the X-radiation via a radiation filter; and
detecting via an electric imaging sensor image data formed by the radiation having penetrated the object to be imaged, wherein
a compression thickness of the object to be imaged is over 20 mm,
the X-radiation is produced using an acceleration voltage of at least 30 kV,
the radiation emitted from the anode is filtered by an Ag filter having a thickness of at least 60 μm, and said radiation containing image data is detected using a sensor based on amorphous selenium technology.

26. The method according to claim 25, wherein the acceleration voltage is substantially in the range of 30-40 kV.

27. The method according to claim 25, wherein the acceleration voltage is around 35 kV.

28. The method according to claim 25, wherein the Ag filter has a thickness below 100 μM.

29. The method according to claim 25, wherein the Ag filter has a thickness of around 75 μm.

30. The method according to claim 25, wherein
the X-radiation is produced using an acceleration voltage substantially in the range of 32-35 kV and a tungsten anode,
the radiation emitted from the anode is filtered using a silver filter substantially having a thickness of 75 μm, and
the radiation containing image information is detected by means of a sensor based on amorphous selenium technology.

31. The method according to claim 25 in which the object to be imaged is a breast, wherein
the breast to be imaged has a compressed thickness of around 20 mm or 40 mm or more,
the X-radiation is produced using an acceleration voltage of substantially 32 kV and a tungsten anode,
the radiation emitted from the anode is filtered using a silver filter substantially having a thickness of 75 μm, and
the radiation containing image information is detected by means of a sensor based on amorphous selenium technology.

32. A method for digital mammography imaging, comprising the steps of:
compressing an object to be imaged so as to be substantially immovable for the imaging;
producing X-radiation via an X-radiation source that comprises a tungsten anode;
filtering the X-radiation via a radiation filter; and
detecting via an electric imaging sensor image data formed by the radiation having penetrated the object to be imaged, wherein
a compression thickness of the object to be imaged is less than 20 mm,
the X-radiation is produced using an acceleration voltage of at least 30 kV,
the radiation emitted from the anode is filtered by a Rh filter having a thickness of around 60 μm, and said radiation containing image data is detected using a sensor based on amorphous selenium technology.
